(19) United States
(12) Patent Application Publication
(10) Pub. No.: US 2014/0342599 A1
(43) Pub. Date: Nov. 20, 2014

(54) ELECTRICAL CONNECTOR DEVICE

(71) Applicant: Molex Incorporated, Lisle, IL (US)

(72) Inventor: Xue-Qing ZHANG, Shanghai (CN)

(73) Assignee: Molex Incorporated, Lisle, IL (US)

(21) Appl. No.: 14/192,397

(22) Filed: Feb. 27, 2014

(30) Foreign Application Priority Data
Feb. 27, 2013 (CN) 201320088571.6

(51) Int. Cl. H01R 13/52

(52) U.S. Cl. CPC H01R 13/5205; H01R 13/5202
USPC 439/521

(57) ABSTRACT

An electrical connection device comprises an outer cage and an electrical connector. The outer cage comprises a plastic casing and a metal plate. The plastic casing has a receiving space and a first opening and a second opening which are opposite. The metal plate comprises a main body and two fixed portions. The main body is embedded in the plastic casing. The two fixed portions are positioned outside the plastic casing, and a bottom surface of the metal plate is partially exposed outside an inner surface of the plastic casing. The electrical connector is positioned in the receiving space of the plastic casing. The metal shell defines a slot and is connected with the metal plate. The insulative housing is fixed to the metal shell. A plurality of terminals are fixed to the insulative housing, and partially extend out of the second opening of the plastic casing.

### RELATED APPLICATIONS

This application claims priority to Chinese Application No. 201320088571.6, filed Feb. 27, 2013, which is incorporated herein by reference in its entirety.

### TECHNICAL FIELD

The present disclosure relates to an electrical connection device.

### BACKGROUND ART

An electronic device connects other devices via an electrical connector. In recent years, the electrical connector has been provided with additional functions (such as a waterproof function) besides a basic connection function.

Chinese patent application No. CN200320120260.X discloses an electrical connector, which comprises an insulative housing, a plurality of conductive terminals received in the insulative housing, an inner shielding shell and an outer shielding shell which are closely adjacent to each other. The inner shielding shell is formed by bending and mating with itself to form an engaging slit. The inner shielding shell covers the outside of the insulative housing. The outer shielding shell is also formed by bending and mating with itself to form an engaging slit. The outer shielding shell covers the outside of the inner shielding shell.

The inner shielding shell and the outer shielding shell of the above electrical connector are sheathed together to increase strength thereof, however, the electrical connector is easily broken and deformed at the engaging slits of the shielding shells after the electrical connector is repeatedly mated and out of mating, as the two shielding shells each have the engaging slit and the strength of the two sheathed shielding shells is still not sufficient. Moreover, the above electrical connector does not have waterproof function, ambient water or moisture easily permeate into the electrical connector from the electrical connector itself or a gap between the electrical connector and a case of an electronic device adjacent to the electrical connector, thereby resulting in a risk in waterproof .

Moreover, FIG. 1 illustrates a connector 1 in a style of waterproof Universal Serial Bus disclosed in Taiwanese utility model patent application No. TW101200858. The connector 1 comprises an insulative housing 11, a plurality of terminals 12, a metal shell 13, and a casing 14. The plurality of terminals 12 are integrally formed to the insulative housing 11. The metal shell 13 is assembled outside the insulative housing 11. The casing 14 is integrally formed on the metal shell 13 and adhered on the metal shell 13.

The connector 1 is fixed via soldering arms 131. The soldering arms 131 are forming by directly cutting the metal shell 13, so the metal shell 13 is left with big through holes 132. The big through holes 132 will make strength of the metal shell 13 not sufficient, and the metal shell 13 is easily deformed under squeeze. These big through holes 132 need to be sealed with an additional new process before the casing 14 is integrally formed, and generally, the through holes 132 are bigger, manufacturing difficulty of the casing 14 is higher. Moreover, the casing 14 is formed on the metal shell 13 by means of over-molding plastic. The metal shell 13 is easily deformed under squeeze after the casing 14 is formed as thermal expansion coefficient of the plastic and the metal is significantly different. Moreover, if the casing 14 is separately formed and then assembled onto the metal shell 13, the casing 14 needs to be prefabricated with open grooves which allow the soldering arms 131 to pass through when the metal shell 13 is assembled. In order to achieve waterproof, the each open groove must be sealed by a sealing glue, thus an additional seal process must be used when the casing 14, which is separately formed, is used.

### SUMMARY OF THE INVENTION

The present disclosure provides an electrical connection device comprising: an outer cage and an electrical connector. The outer cage comprises a plastic casing and a metal plate. The plastic casing has a receiving space and a first opening and a second opening which are opposite. The metal plate comprises a main body and two fixed portions. The main body is embedded in the plastic casing and has a top surface and a bottom surface. The two fixed portions are positioned outside the plastic casing. The bottom surface of the metal plate is partially exposed outside an inner surface of the plastic casing. The electrical connector comprises a metal shell, an insulative housing and a plurality of terminals. The electrical connector is positioned in the receiving space of the plastic casing. The metal shell defines a slot and connects with the metal plate, and the slot faces the first opening of the plastic casing. The insulative housing is fixed to the metal shell. The plurality of terminals are fixed to the insulative housing, and partially extend out of the second opening of the plastic casing.

In an embodiment, the plastic casing has a recessed groove, the recessed groove extends from the outer surface of the plastic casing to the top surface of the metal plate, and at least one laser welding spot is present on the metal plate within the recessed groove. In an embodiment, the electrical connection device further comprises a sealing glue, the sealing glue seals the second opening of the plastic casing. In an embodiment, the whole electrical connector is received in the plastic casing. In an embodiment, the electrical connection device further comprises a sealing glue, the sealing glue seals a gap between the plastic casing and the insulative housing of the electrical connector at the second opening of the plastic casing.

In an embodiment, the electrical connection device further comprises a sealing glue, the sealing glue seals gaps between the insulative housing and the terminals of the electrical connector. In an embodiment, a rear end portion of the insulative housing seals the second opening. In an embodiment, a conductive adhesive is applied at a connection point between the metal plate and the metal shell or the metal plate directly contacts the metal shell. In an embodiment, the second opening of the plastic casing allows the electrical connector to insert into the receiving space, and the first opening is smaller than the second opening. In an embodiment, the plastic casing and the electrical connector are engaged with non-adhesive or friction.

### BRIEF DESCRIPTION OF THE DRAWINGS

FIG. 1 illustrates an connector in a style of waterproof Universal Serial Bus in prior art;

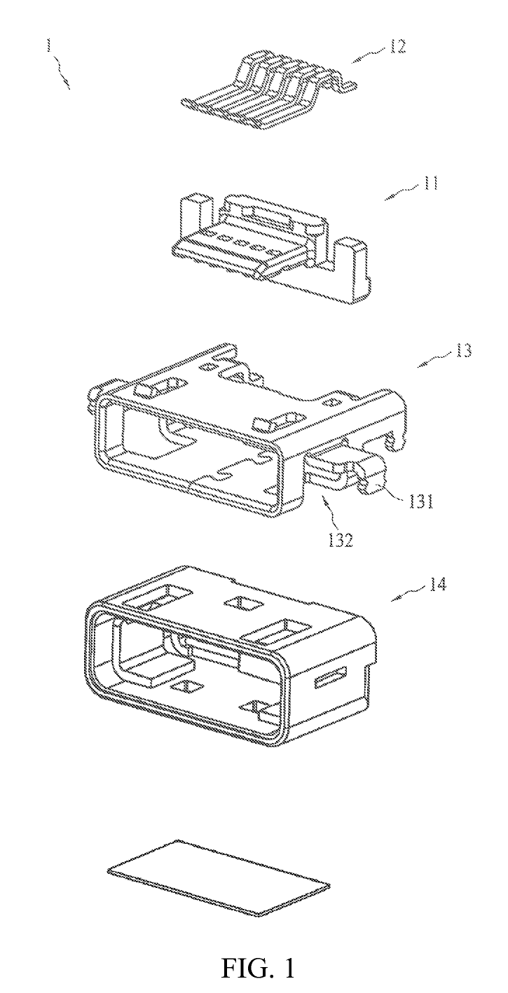

FIG. 2 is a schematic view illustrating an electrical connection device of an embodiment of the present disclosure;

FIG. 3 is another schematic view illustrating the electrical connection device of the embodiment of the present disclosure;

FIG. 4 is an exploded schematic view illustrating the electrical connection device of the embodiment of the present disclosure;

FIG. 5 is another exploded schematic view illustrating the electrical connection device of the embodiment of the present disclosure;

FIG. 6 is another exploded schematic view illustrating the electrical connection device of the embodiment of the present disclosure;

FIG. 7 is another exploded schematic view illustrating the electrical connection device of the embodiment of the present disclosure;

FIG. 8 is a front view illustrating the electrical connection device of the embodiment of the present disclosure;

FIG. 9 is a sectional view taken along a line 100-100 of FIG. 8;

FIG. 10 is a perspective sectional view illustrating the electrical connection device of the embodiment of the present disclosure;

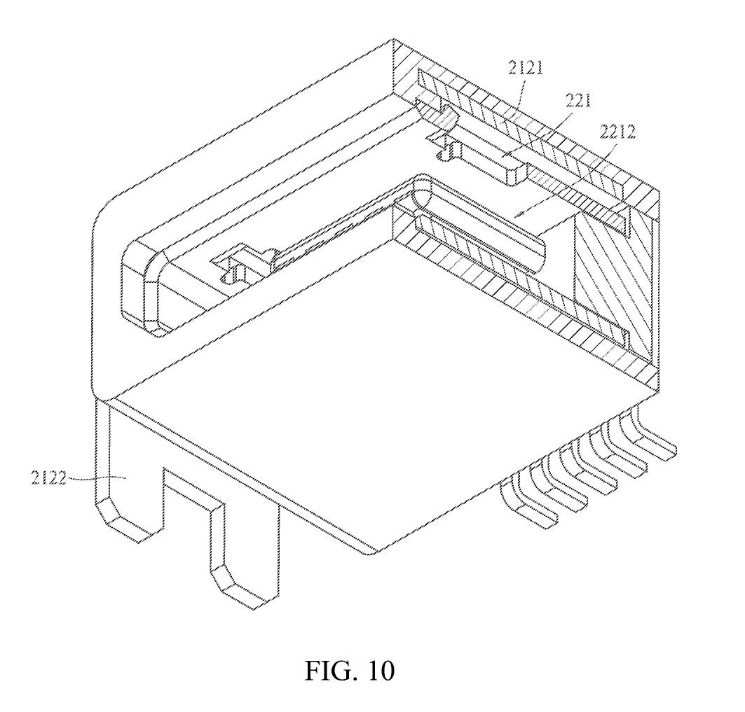

FIG. 11 is a top view illustrating the electrical connection device of the embodiment of the present disclosure; and

FIG. 12 is a sectional view taken along a line 200-200 of FIG. 11.

### DETAILED DESCRIPTION OF THE PREFERRED EMBODIMENTS

The embodiments of the present disclosure are described in detail in combination with the drawings. It should be noted that, positional directions or movement directions (such as up, down, left, right, front, rear and the like) used for explaining structures or components of the embodiments of the present disclosure, are not absolute, but relative. When the disclosed component is the same as the embodiment of the accompanying figures in arrangement manner, these used directions may be appropriate. However, if the position or the reference coordinate system of the disclosed embodiment changes, the used direction will change accordingly.

In view of the foregoing problems, an object of the present disclosure is to provide a new electrical connection device. Beneficial effects of the present disclosure include, as the electrical connector is positioned in the receiving space of the plastic casing, the fact that the plastic casing may protect the metal shell of the electrical connector, which may avoid the electrical connector being expanded and opened at the engaging slit. The metal plate is partially embedded in the plastic casing to strengthen the plastic casing and the plastic casing is not easily deformed, therefore it may prevent the metal shell of the electrical connector from being expanded and opened at the engaging slit after the electrical connector is repeatedly mated and out of mating. The metal plate has fixed portions, and thus the metal shell of the electrical connector does not need to be formed with the fixed portions, the metal shell may keep integrity and maintain a higher strength and is not easily deformed, therefore it can avoid the metal shell being expanded and opened at the engaging slit after the electrical connector is repeatedly mated and out of mating.

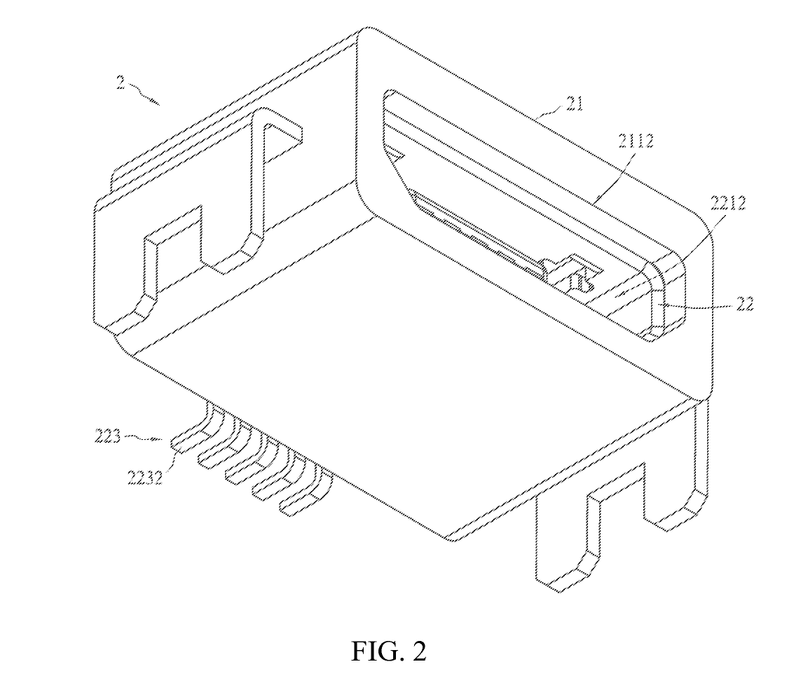

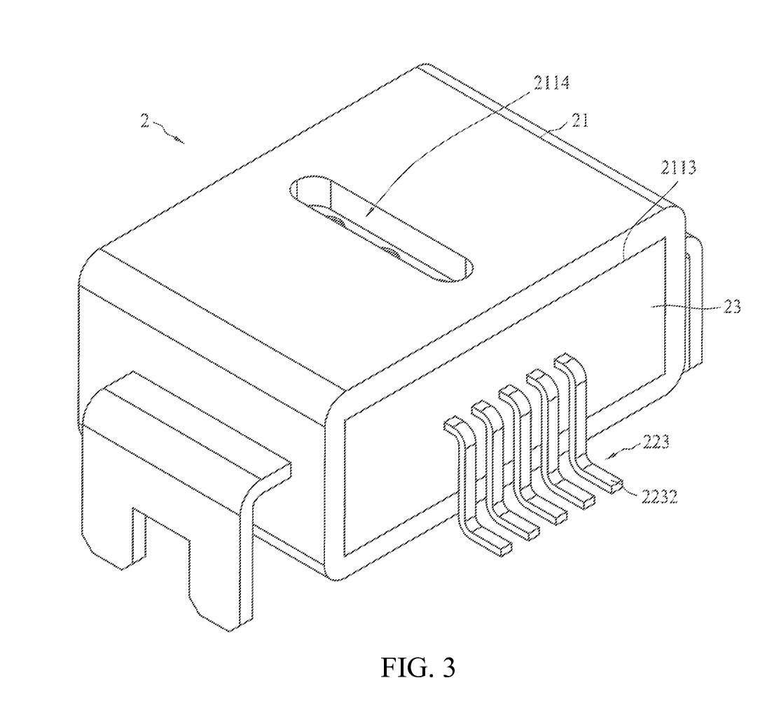

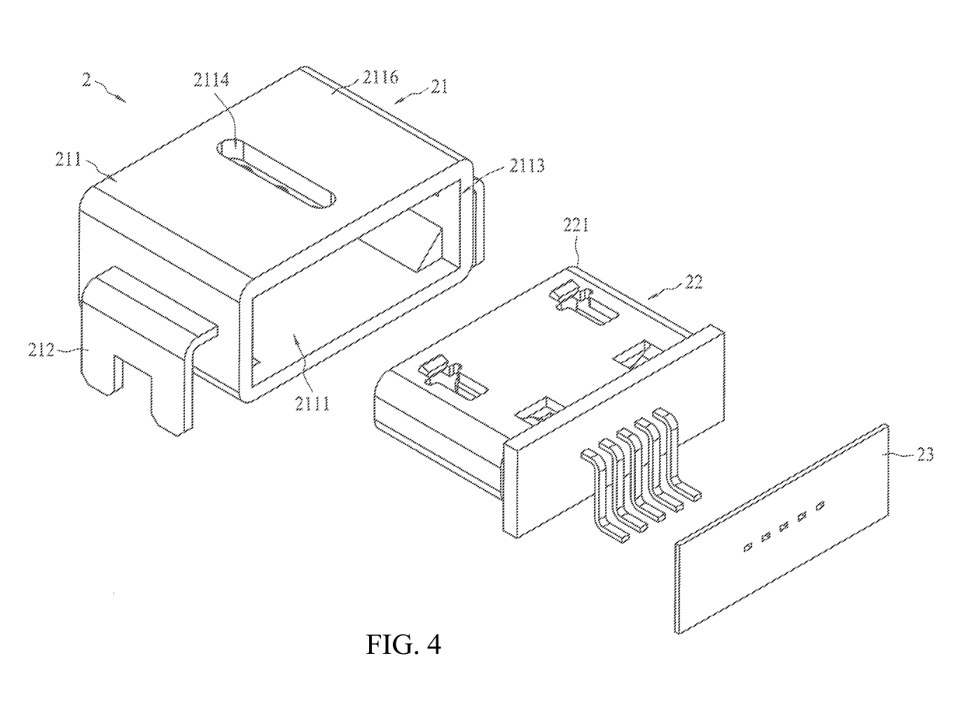

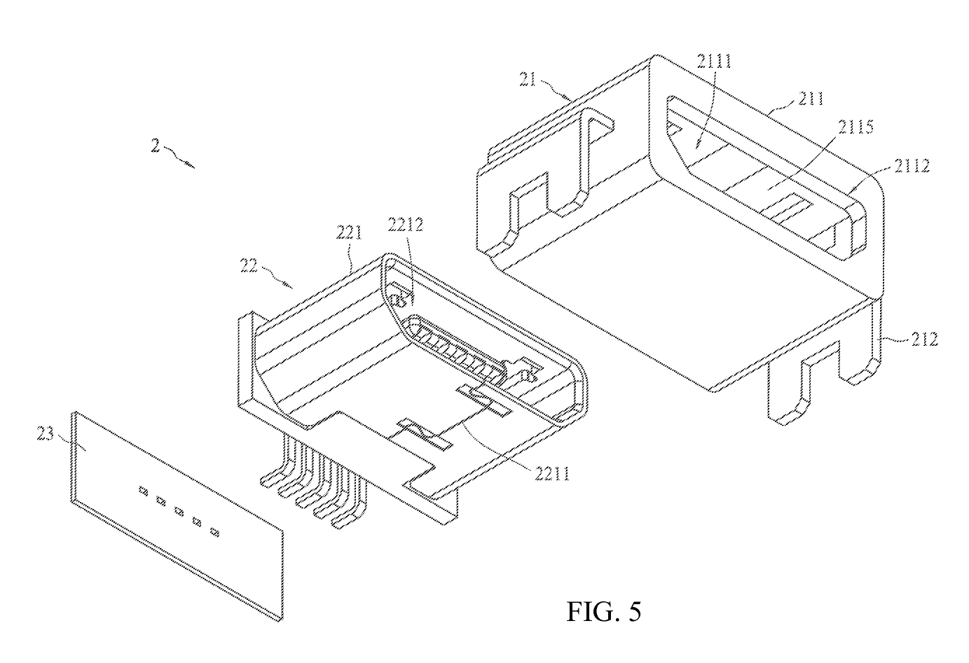

FIG. 2 is a schematic view illustrating an electrical connection device 2 of an embodiment of the present disclosure. FIG. 3 is another schematic view illustrating the electrical connection device 2 of the embodiment of the present disclosure. FIG. 4 is an exploded schematic view illustrating the electrical connection device 2 of the embodiment of the present disclosure. FIG. 5 is another exploded schematic view illustrating the electrical connection device 2 of the embodiment of the present disclosure. Referring to FIG. 2 and FIG. 3, the electrical connection device 2 may be mated with a mating connector or an electronic device. In an embodiment, the electrical connection device 2 may be a Universal Serial Bus (USB) connector, but the present disclosure should not be limited to this.

Referring to FIGS. 2-5, the electrical connection device 2 comprises an outer cage 21 and an electrical connector 22. The electrical connector 22 comprises a metal shell 221, the metal shell 221 is formed by bending and is formed with an engaging slit 2211. The outer cage 21 may not have an engaging slit, and the outer cage 21 surrounds the electrical connector 22, therefore the metal shell 221 of the electrical connector 22, which is under the protection of the outer cage 21, is not easily expanded and opened at the engaging slit 2211 after the electrical connector 22 is repeatedly mated or out of mating.

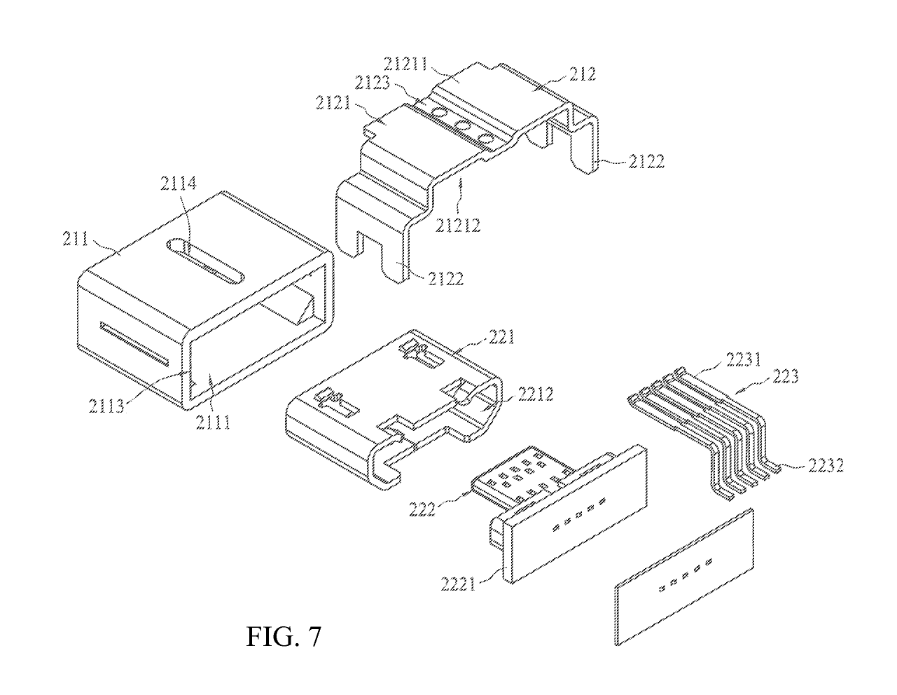

Referring to FIG. 7, the outer cage 21 comprises a plastic casing 211 and a metal plate 212. The plastic casing 211 may not have an engaging slit by mean of injection molding. The metal plate 212 is fixed to the plastic casing 211 by means of insert molding.

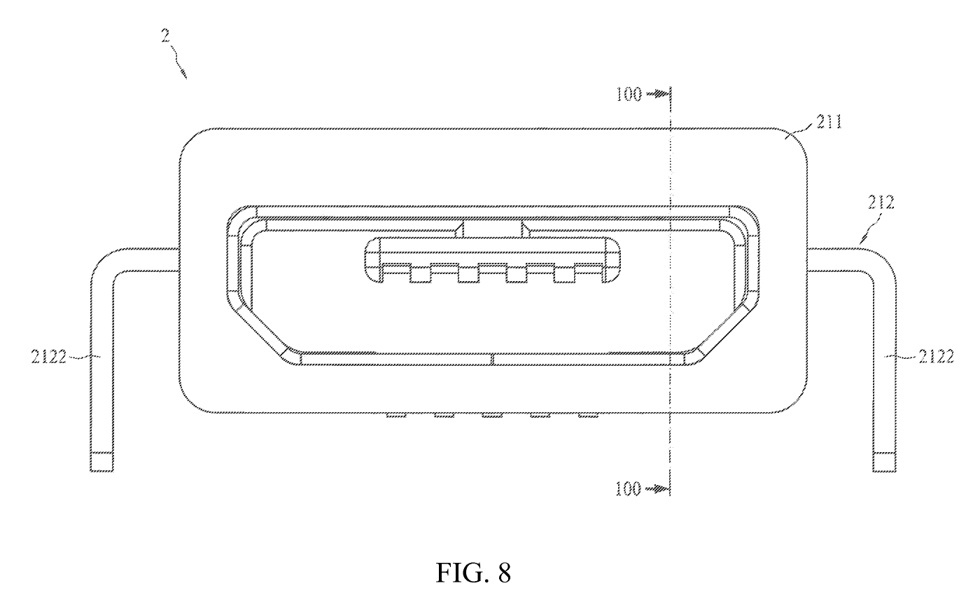

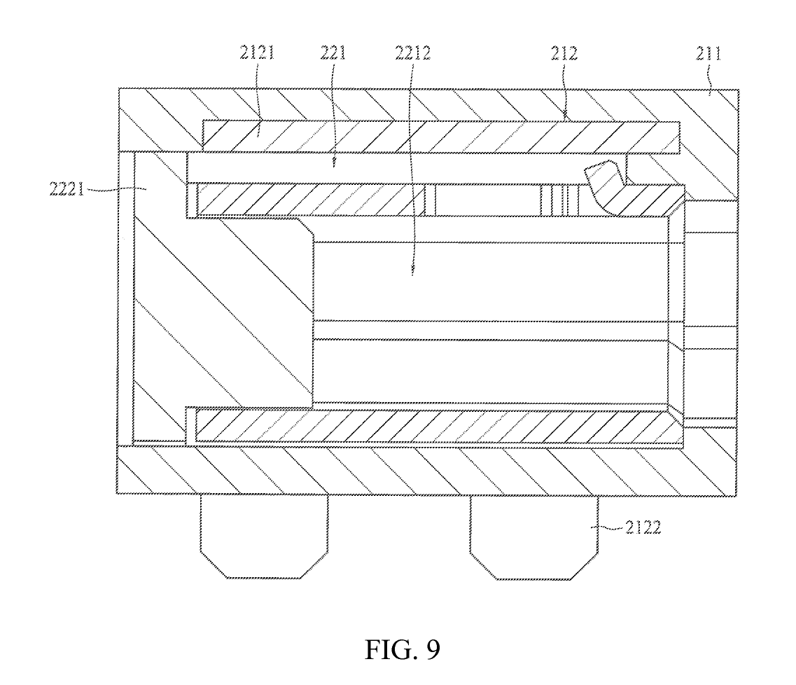

Referring to FIGS. 7-9, the metal plate 212 may comprise a main body 2121 and two fixed portions 2122. The two fixed portions 2122 may be positioned outside the plastic casing 211. The fixed portions 2122 may be used to fix the electrical connection device 2, for example, to fix the electrical connection device 2 on a circuit board. In an embodiment, the fixed portions 2122 may be electrically connected to the circuit board. In an embodiment, the fixed portions 2122 may be grounded. In an embodiment, the fixed portions 2122 may be soldered on the circuit board, but the present disclosure is not so limited. The main body 2121 may be partially embedded in the plastic casing 211 to strength the plastic casing 211, and makes the plastic casing 211 not easily deformed, therefore the metal shell 221 of the electrical connector 22 is not easily expanded and opened at the engaging slit 2211 after the electrical connector 22 is repeatedly mated or out of mating. As the fixed portions 2122 of the electrical connection device 2 provided to the metal plate 212 instead of the metal shell 221 of the electrical connector 22, the fixed portions 2122 do not need to be formed by cutting the metal shell 221, therefore the metal shell 221 may maintain a higher strength and is not easily deformed.

In an embodiment, as shown in FIG. 7, the main body 2121 of the metal plate 212 may be formed as a configuration with a channel 2123, therefore the main body 2121 may be partially embedded in the plastic casing 211, and a bottom surface of the main body 2121 may be partially exposed outside the plastic casing 211, and the configuration with the channel 2123 may increase rigidity of the metal plate 212, which makes the outer cage 21 not easily deformed under a force and can better ensure that the metal shell 221 of the electrical connector 22 will not be expanded and opened at the engaging slit 2211.

Referring to FIG. 4, FIG. 5 and FIG. 7, the plastic casing 211 has a receiving space 2111, a first opening 2112, and a second opening 2113. The first opening 2112 may be opposite to the second opening 2113. The electrical connector 22 is positioned in the receiving space 2111 of the plastic casing 211.

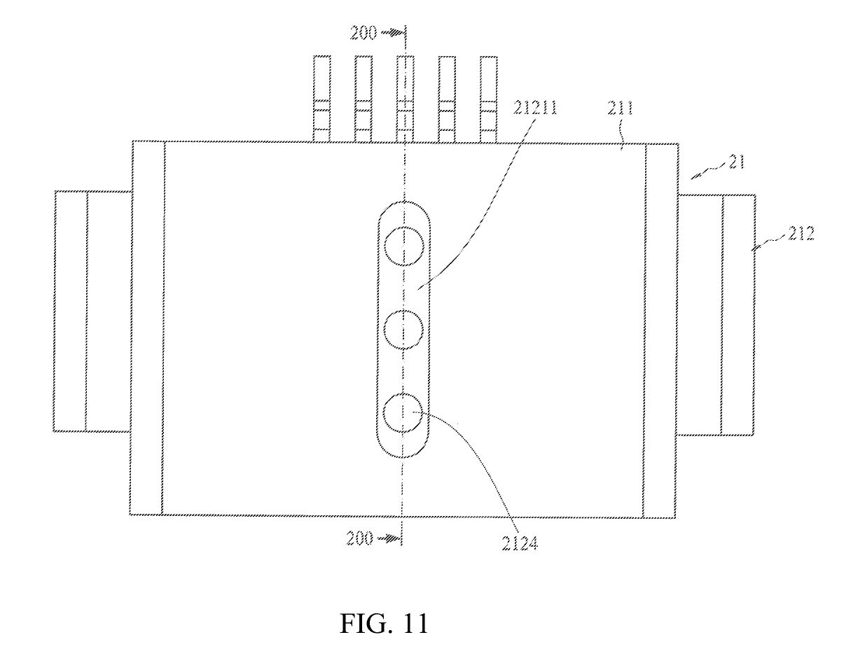

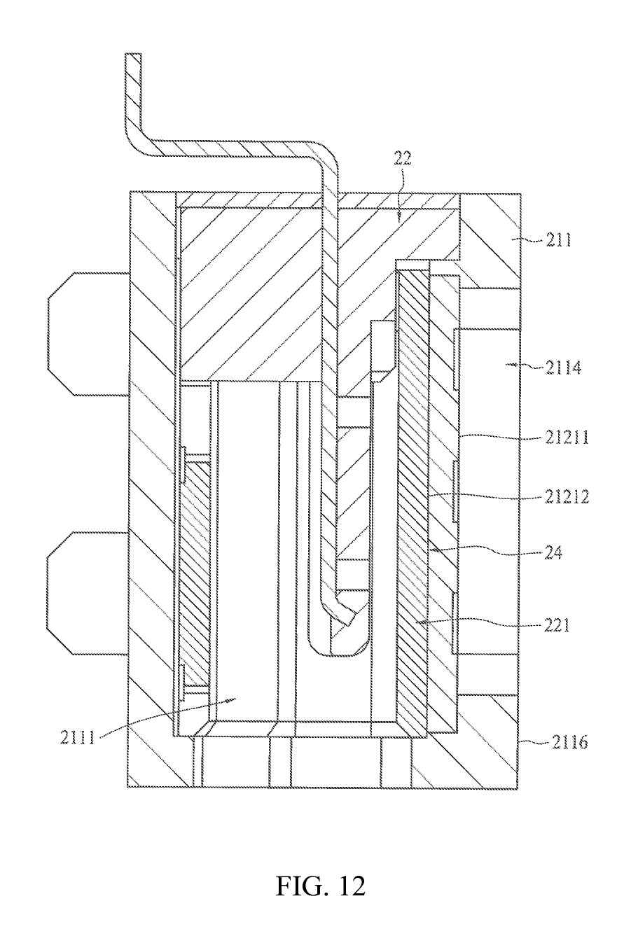

Referring to FIG. 7, FIG. 11 and FIG. 12, the main body 2121 of the metal plate 212 has a top surface 21211 and a bottom surface 21212. The bottom surface 21212 of the main body 2121 is at least partially exposed outside the inner surface 2115 of the plastic casing 211 to be connected with the electrical connector 22.

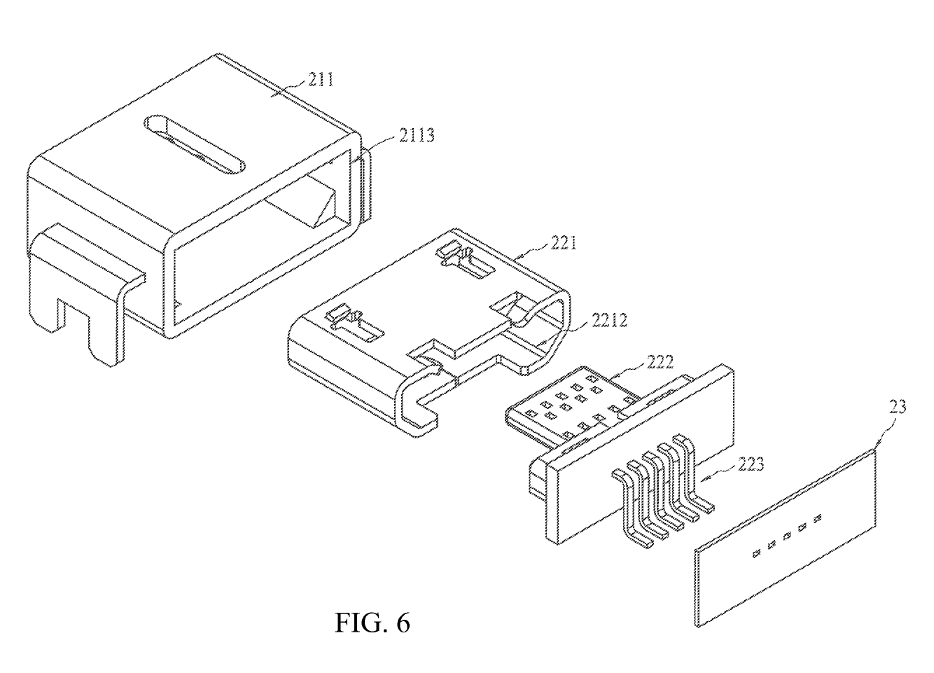

Referring to FIG. 6 and FIG. 7, the electrical connector 22 may further comprise an insulative housing 222 and a plurality of terminals 223. The metal shell 221 may be formed by bending and may define a slot 2212. The slot 2212 may be mated with a mating connector or an electronic device. The insulative housing 222 can be fixed to the metal shell 221. The plurality of terminals 223 may be fixed to the insulative housing 222. The terminal 223 may comprise a contact portion 2231 and a soldering portion 2232. The contact portions 2331 may be positioned in the slot 2212 to electrically connect the mating connector or the electronic device to be mated after the metal shell 221 and the insulative housing 222 are assembled. As shown in FIG. 12, after the electrical connection device 2 is assembled, the metal shell 221 of the electrical connector 22 may contact the exposed part of the bottom surface 21212 of the metal plate 212, therefore the metal shell 221 of the electrical connector 22 is also grounded when the fixed portion 2122 of the metal plate 212 is grounded.

The metal plate 212 may be connected with the electrical connector 22. In an embodiment, the electrical connector 22 is fixed to the metal plate 212 by means of spot welding. As shown in FIG. 7, FIG. 11 and FIG. 12, the plastic casing 211 may be further formed with a recessed groove 2114. The recessed groove 2114 of the plastic casing 211 may extend from an outer surface 2116 of the plastic casing 211 toward the inner surface 2115 and extend to the top surface 21211 of the metal plate 212 so as to expose a part of the top surface 21211. As the metal plate 212 is embedded in the plastic casing 211, and the recessed groove 2114 of the plastic casing 211 is formed on the top surface 21211 of the metal plate 212, therefore the recessed groove 2114 may be sealed, moisture or water cannot permeate into the plastic casing 211 via the recessed groove 2114, therefore even if the recessed groove 2114 has been formed, the electrical connection device 2 can still be sealed and perform waterproof function. After the electrical connector 22 is assembled into the plastic casing 211, laser spot welding is performed on the exposed part of the top surface 21211 of the recessed groove 2114, and at least one laser welding spot 2124 is formed on the metal plate 212 of the recessed groove 2114, therefore the electrical connector 22 is fixed to the metal plate 212. In another embodiment, the electrical connector 22 is adhered to the metal plate 212, and is connected with the metal plate 212, thus the plastic casing 211 does not need to be formed with the recessed groove 2114; in other words, a conductive adhesive is applied at a connection point 24 between the metal plate 212 and the metal shell 221 to fix the metal plate 212 and the metal shell 221 together (FIG. 12). In another embodiment, the electrical connector 22 is pressed against the metal plate 212, therefore the metal shell 221 of the electrical connector 22 directly contact the bottom surface 21212 of the metal plate 212 exposed outside the inner surface 2115 of the plastic casing 211.

Referring to FIG. 5 and FIG. 6, the second opening 2113 of the plastic casing 211 is large enough to allow the electrical connector 22 to enter into the receiving space 2111 and the first opening 2112 is smaller than the second opening 2113 to make the electrical connector 22 cannot be inserted into the first opening 2112, therefore the electrical connector 22 may be assembled from the second opening 2113 and is stopped by the first opening 2112 and is left in the receiving space 2111. As shown in FIG. 2 and FIG. 3, after the electrical connector 22 is assembled into the plastic casing 211, the slot 2212 of the electrical connector 22 faces the first opening 2112 of the plastic casing 211, the terminals 223 extend toward the second opening 2113 of the plastic casing 211, and the terminals 223 partially extend out of the second opening 2113, and the soldering portions 2232 are positioned outside the plastic casing 211.

As the electrical connector 22 is assembled into the plastic casing 211, the plastic casing 211 is not over molded on the electrical connector 22, therefore the electrical connector 22 and the plastic casing 211 are engaged with non-adhesive.

In an embodiment, the receiving space 2111 of the plastic casing 211 may be slightly larger than the electrical connector 22, so that a gap may be formed between the electrical connector 22 and the plastic casing 211, the electrical connector 22 may freely move in the receiving space 2111. In an embodiment, the receiving space 2111 of the plastic casing 211 may be slightly smaller than the electrical connector 22; when the electrical connector 22 is assembled into the receiving space 2111 of the plastic casing 211, the electrical connector 22 and the plastic casing 211 will contact and form friction therebetween, thus the electrical connector 22 and the plastic casing 211 are engaged with friction.

In an embodiment, as shown in FIG. 3 and FIG. 4, the electrical connection device 2 may comprise a sealing glue 23, the sealing glue 23 seals the second opening 2113 of the plastic casing 211, therefore the electrical connection device 2 is sealed and only the first opening 2112 is opened to the ambient, water or moisture will be stopped by the plastic casing 211 and the sealing glue 23 and will not permeate into the electronic device mounted with the electrical connection device 2. In an embodiment, as shown in FIG. 3, the plastic casing 211 may receive the whole electrical connector 22, therefore when the second opening 2113 of the plastic casing 211 is sealed by the sealing glue 23, the sealing glue 23 and the plastic casing 211 constitute a closed cover, so water or moisture will be stopped by the plastic casing 211 and the sealing glue 23 and will not permeate into the electronic device mounted with the electrical connection device 2.

In another embodiment, the electrical connection device 2 may comprise a sealing glue, the sealing glue does not seal the whole second opening 2113 of the plastic casing 211, but only seals the gap between the plastic casing 211 and the insulative housing 222 of the electrical connector 22 at the second opening 2113 of the plastic casing 211.

In another embodiment, as shown in FIG. 7, the electrical connection device 2 may comprise a sealing glue; the insulative housing 222 of the electrical connector 22 has a rear end portion 2221 matched with the second opening 2113 of the plastic casing 211 and sealing the second opening 2113, wherein the sealing glue seals gaps between the plurality of terminals 223 and the insulative housing 222 of the electrical connector 22, therefore it may avoid water or moisture penetrating into the electronic device mounted with the electrical connection device 2.

The electrical connection device of the present disclosure comprises an outer cage and an electrical connector. The outer cage does not have an engaging slit and may receive the electrical connector. As the outer cage does not have the engaging slit, the outer cage will not be expanded and opened and it may prevent the metal shell of the electrical connector from being expanded and opened at the engaging slit after the electrical connector is repeatedly mated and out of mating. In some embodiments, the outer cage comprises a plastic casing and a metal plate, the metal plate is partially embedded in the plastic casing to strengthen the plastic casing, and thus the plastic casing is not easily deformed, therefore it can prevent the metal shell of the electrical connector from being expanded and opened at the engaging slit after the electrical connector is repeatedly mated and out of mating. In some embodiments, the metal plate has fixed portions, thereby the metal shell of the electrical connector does not need to be formed with the fixed portions, the metal shell may keep integrity in structure and maintain a higher strength and is not easily deformed, and may avoid the metal shell being expanded and opened at the engaging slit after the electrical connector is repeatedly mated and out of mating. In some embodiments, the electrical connector is assembled into the outer cage, therefore the metal shell of the electrical connector will not be deformed under squeeze. In some embodiments, the plastic casing has a first opening and a second opening, the mating connector or the electronic device may mate with the electrical connector via the first opening, the gap at the second opening are sealed by the sealing glue or the whole second opening is sealed by the sealing glue, therefore the plastic casing is sealed by the sealing glue besides the first opening to form a closed cover, thus can prevent water or moisture from permeating into the electronic device mounted with the electrical connection device. As only the second opening or the gap at the second opening needs to be sealed, the process of the sealing is easy, the electrical connection device is easy to be manufactured.

Technical contents and technical features of the present disclosure are disclosed as above, but person skilled in the art still may make various substitutions and modifications without departing from the spirit of the present disclosure based on the teaching and disclosure of the present disclosure. Therefore, the protection scope is not limited by the embodiments, but also includes various substitutions and modifications within the scope of the present disclosure and the appended Claims.

What is claimed is:

1. An electrical connection device, comprising:
an outer cage, the outer cage comprising:
a plastic casing, the plastic casing having a receiving space and a first opening and a second opening which are opposite; and
a metal plate, the metal plate comprising a main body and two fixed portions, the main body being embedded in the plastic casing and having a top surface and a bottom surface, the two fixed portions being positioned outside the plastic casing, and the bottom surface of the metal plate being partially exposed outside an inner surface of the plastic casing; and
an electrical connector, the electrical connector being positioned in the receiving space of the plastic casing, the electrical connector comprising:
a metal shell, the metal shell defining a slot and connecting with the metal plate, and the slot facing the first opening of the plastic casing;
an insulative housing, the insulative housing being fixed to the metal shell; and
a plurality of terminals, the plurality of terminals being fixed to the insulative housing, and partially extending out of the second opening of the plastic casing.

2. The electrical connection device according to claim 1, wherein the plastic casing has a recessed groove, the recessed groove extends from the outer surface of the plastic casing to the top surface of the metal plate, and at least one laser welding spot is present on the metal plate within the recessed groove.

3. The electrical connection device according to claim 1 or claim 2, wherein the electrical connection device further comprises a sealing glue, the sealing glue seals the second opening of the plastic casing.

4. The electrical connection device according to claim 3, wherein the whole electrical connector is received in the plastic casing.

5. The electrical connection device according to claim 1 or claim 2, wherein the electrical connection device further comprises a sealing glue, the sealing glue seals a gap between the plastic casing and the insulative housing of the electrical connector at the second opening of the plastic casing.

6. The electrical connection device according to claim 1 or claim 2, wherein the electrical connection device further comprises a sealing glue, the sealing glue seals gaps between the insulative housing and the terminals of the electrical connector.

7. The electrical connection device according to claim 6, wherein a rear end portion of the insulative housing seals the second opening.

8. The electrical connection device according to claim 1, wherein a conductive adhesive is applied at a connection point between the metal plate and the metal shell or the metal plate directly contacts the metal shell.

9. The electrical connection device according to claim 1, wherein the second opening of the plastic casing allows the electrical connector to insert into the receiving space, and the first opening is smaller than the second opening.

10. The electrical connection device according to claim 1, wherein the plastic casing and the electrical connector are engaged with non-adhesive or friction.
